(19) United States
(12) Patent Application Publication
(10) Pub. No.: US 2025/0163992 A1
(43) Pub. Date: May 22, 2025

(54) ABSORBER FOR ABSORBING A VIBRATION ACTING UPON A STRUCTURE AND METHOD FOR MAKING THE SAME

(71) Applicant: Toyota Motor Engineering & Manufacturing North America, Inc., Plano, TX (US)

(72) Inventors: Xiaopeng Li, Ann Arbor, MI (US); Taehwa Lee, Ann Arbor, MI (US); Ziqi Yu, Ann Arbor, MI (US); Yuyang Song, Ann Arbor, MI (US); Xintong Deng, Plymouth, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/515,395

(22) Filed: Nov. 21, 2023

(51) Int. Cl. F16F 15/02; G06F 30/20; G06F 113/10

(52) U.S. Cl. CPC F16F 15/022; G06F 30/20; F16F 2226/04; F16F 2228/066; G06F 2113/10

(57) ABSTRACT

Described herein are absorbers for absorbing vibrations acting upon a structure and methods for making the same. In one example, the absorber may be designed by defining a design domain for the absorber and utilizing a topological optimization process to design a shape of the absorber within the design domain to maximize the absorption performance of the absorber.

### TECHNICAL FIELD

The subject matter described herein relates, in general, to absorbers for absorbing a vibration acting upon a structure and methods for making the same.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Structural-born noise and vibrations acting upon a structure are generally viewed as being problematic. Traditional methodologies for attenuating structural born noise and vibrations typically involve the use of a dampening material that is bonded to the structure itself. However, damping materials generally occupy a large area and usually result in much more added weight to the structure.

### SUMMARY

This section generally summarizes the disclosure and is not a comprehensive explanation of its full scope or all its features.

In one embodiment, a method for designing an absorber for absorbing a vibration acting upon a structure includes the steps of defining a design domain for the absorber and utilizing a topological optimization process to design a shape of the absorber within the design domain to maximize the absorption performance of the absorber.

In another embodiment, an absorber for absorbing a vibration acting upon a structure has a structure designed using a topological optimization process to design a shape of the absorber within a design domain that maximizes the absorption performance of the absorber.

Further areas of applicability and various methods of enhancing the disclosed technology will become apparent from the description provided. The description and specific examples in this summary are intended for illustration only. They are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a system that includes a structure in the form of a beam having a flexural wave acting upon it.

FIGS. 2A-2C illustrate the progression of the use of topological optimization to create an absorber for absorbing vibrations acting upon a structure.

FIGS. 3A-3D illustrate different examples of a design space for designing an absorber using a topological optimization process.

FIG. 4 illustrates a design system that utilizes a topological optimization process to design an absorber.

FIG. 5 illustrates an absorber designed via a topological optimization process attached to a beam to absorb flexural waves acting upon the beam.

FIG. 6 illustrates a broadband absorption spectrum of the design flexural wave absorber via topological optimization.

FIGS. 7A-7H illustrate the displacement field amplitudes (mode shapes) of an absorber at different eigenfrequencies.

FIG. 8 illustrates the performance of absorbers design utilizing a topological optimization process in comparison to other absorption techniques.

FIG. 9 illustrates a method that utilizes a topological optimization process to design an absorber.

### DETAILED DESCRIPTION

Described are lightweight absorbers and methods for making lightweight absorbers for absorbing vibrations, such as flexural waves acting upon a structure utilizing a topological optimization process. A lightweight absorber created by this methodology can be placed near the end of a structure, such as a beam, and can absorb flexural waves acting upon the structure.

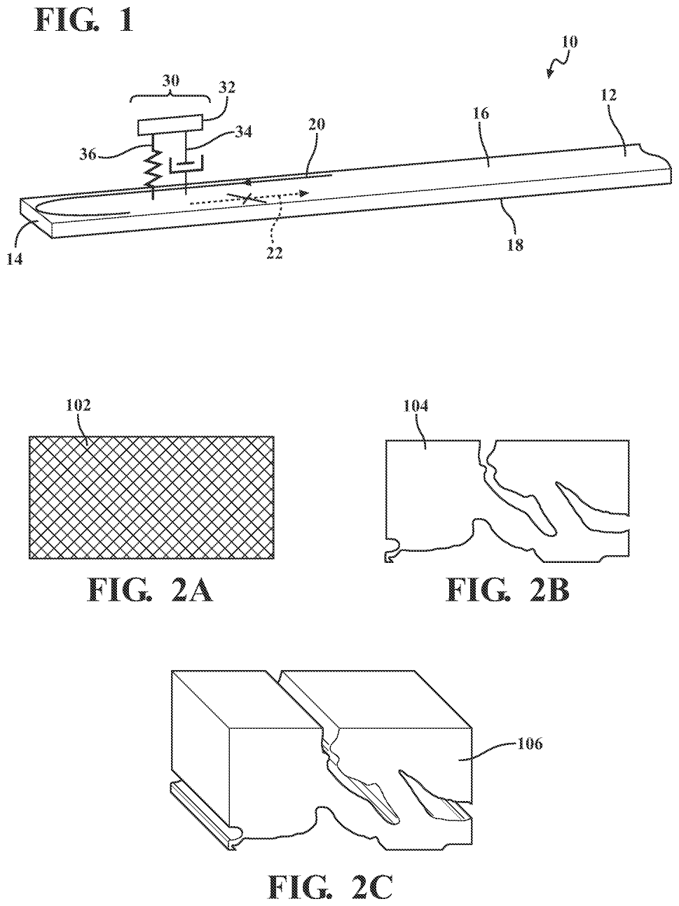

To better understand the absorbers and methods for making the absorbers described herein, reference is made to FIG. 1, which illustrates a system 10 that includes a structure in the form of a beam 12 having a top side 16 and a bottom side 18. The beam 12, in this example, has an incident flexural wave 20 acting upon it. Without any absorption, the incident flexural wave 20 would typically travel to the end 14 of the beam 12, where it is reflected in the other direction as a reflected wave 22. However, in this example, the system 10 includes an absorber 30 that has been designed to absorb the incident flexural wave 20 so that the amplitude of a reflected wave 22 is minimized or eliminated. Worth to notice that the boundary 14 in the current case study is a free end, but it could be other types, such a a fixed end, simply supported, or any other types. The coupling distance and the mass spring damper parameters need to be adjusted to realize fully absorption.

The absorber 30 is shown as a mass-spring-damper-model that includes a mass 32, a damper 34, and a spring 36. Depending on the frequency of the incident flexural wave 20 to be absorbed, the absorber 30 can have appropriate values for the mass 32, the damper 34, and the spring 36 and the coupling distance L to the boundary such that the resonant frequency of the absorber 30 is appropriate for absorbing the incident flexural wave 20. In some cases, the resonant frequency of the absorber 30 may be substantially equal (within 25%) of the frequency of the incident flexural wave 20 to be absorbed. Additionally, the performance of the absorber 30 is also dependent upon the length L that the absorber 30 is placed from the end 14 of the beam 12.

As mentioned in the background section, there are a number of different methodologies for absorbing flexural waves acting on a structure, such as the beam 12. However, many of these methodologies involve the use of heavier materials, such as damping materials, attached to the structure. The absorber and method for making the absorber described herein utilizing topological optimization results in a lightweight absorber that can absorb a broad range of frequencies of incident flexural waves acting upon the structure.

Topological optimization is a mathematical method that optimizes material layout within a given design domain for a given set of boundary conditions and constraints with the goal of maximizing the performance of the system. As such, topological optimization may create a design that can attain any shape within the design domain instead of dealing with predefined configurations. In this case, performance would be reducing vibrations acting upon the structure across a given frequency range. As such, topological optimization would result in a design for an absorber that is within the design domain but also maximizes the performance of the absorber such that the absorber maximizes absorbing vibrations acting upon the structure at a defined frequency range.

Moreover, FIGS. 2A-2C illustrate the progression of the use of topological optimization to create an absorber. FIG. 2A illustrates a design space 102. Typically, the design space 102 is a two-dimensional space having a length and a height. The width is typically a fixed amount that matches the width of the structure, such as the width of the beam 12. As will be described in more detail later in this description, topological optimization has an optimization objective that will result in the absorber design 104 shown in FIG. 2B. Once the absorber design 104 is determined through the topological optimization process, the absorber design 104 can be used to create the absorber 106, shown in FIG. 2C. The absorber 106 may be made through any known manufacturing process. In one particular process, the absorber 106 may be made via a three-dimensional printing process.

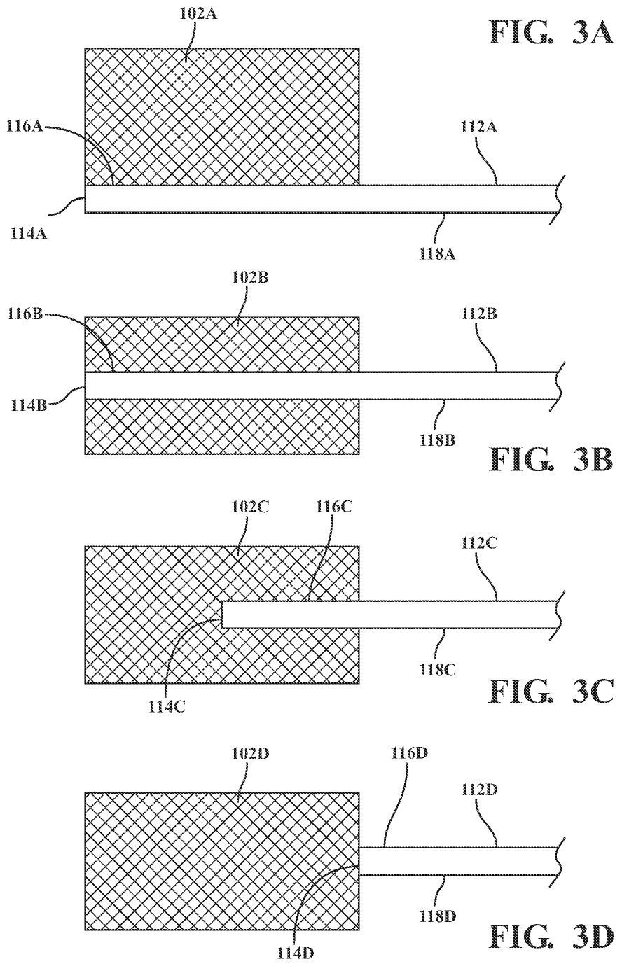

It should be understood that the design space 102 can vary in size and shape, depending on the placement of the absorber with respect to the beam. For example, FIGS. 3A-3D illustrate different examples of the design space 102A-102D. Moreover, in each of these examples, FIGS. 3A-3D illustrate beams 112A-112D having ends 114A-114D, respectively. Additionally, the beams 112A-112D may have top sides 116A-116D and bottom sides 118A-118D, respectively.

In FIG. 3A, the design space 102A is located near the end 114A of the beam 112A and is located above the top side 116A of the beam 112A. As such, any absorber produced using the design space 102A would be attached to the top side 116A near the end 114A of the beam 112A. In FIG. 3B, the design space 102B is located both above the top side 116B and below the bottom side 118B. As such, any absorber produced using the design space 102B would be connected and located to both the top side 116B and the bottom side 118B near the end 114B. In FIG. 3C, the design space 102C is such that it at least partially envelops portions of the beam 112C. Therefore, any absorber produced using the design space 102C would result in an absorber that allows for the end 114C of the beam 112C to be inserted into the absorber. In FIG. 3D, the design space 102D is similar to the design space 102A, but will result in an absorber that is attached directly to the end 114D of the beam 112D without being in contact with the top side 116D or the bottom side 118D of the beam 112D.

Again, it should be understood that the example design spaces 102A-102D are merely examples, and the design space can vary from application to application and should not be limited to just examples given in FIGS. 3A-3D. For example, the design space could be away from the boundary end.

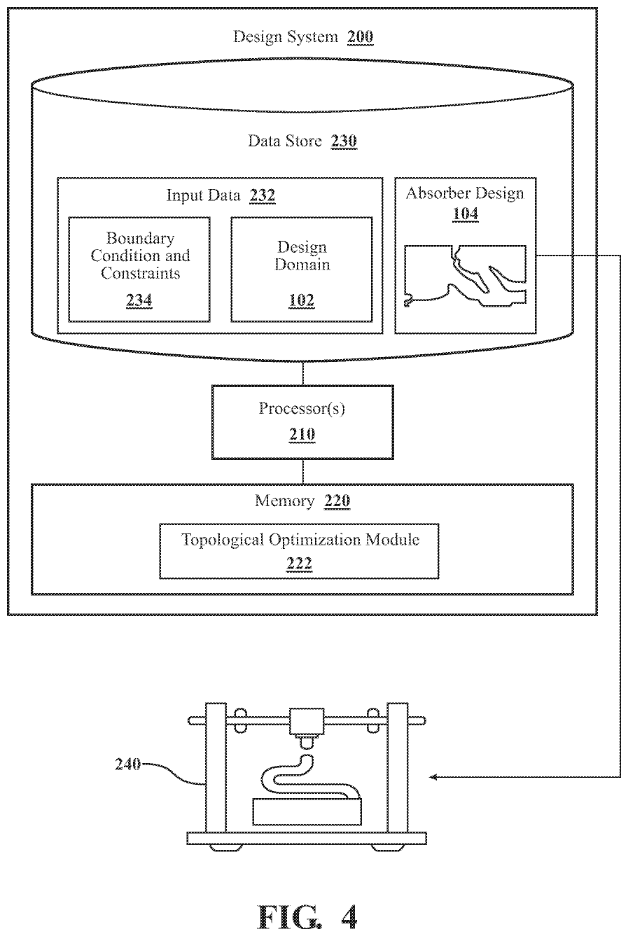

With reference to FIG. 4, one embodiment is shown of a design system 200 for designing absorbers using topological optimization, such as the absorber 106 of FIG. 2C. As shown, the design system 200 includes one or more processor(s) 210. Accordingly, the processor(s) 210 may be a part of the design system 200 or the design system 200 may access the processor(s) 210 through a data bus or another communication path. In one or more embodiments, the processor(s) 210 is an application-specific integrated circuit that is configured to implement functions associated with a topological optimization module 222. In general, the processor(s) 210 is an electronic processor, such as a microprocessor, that is capable of performing various functions as described herein.

In one embodiment, the design system 200 includes a memory 220 that stores the topological optimization module 222. The memory 220 may be a random-access memory (RAM), read-only memory (ROM), a hard disk drive, a flash memory, or other suitable memory for storing the topological optimization module 222. The topological optimization module 222 is, for example, computer-readable instructions that, when executed by the processor(s) 210, cause the processor(s) 210 to perform the various functions disclosed herein.

Furthermore, in one embodiment, the design system 200 includes a data store 230. The data store 230 is, in one embodiment, an electronic data structure such as a database that is stored in the memory 220 or another memory and that is configured with routines that can be executed by the processor(s) 210 for analyzing stored data, providing stored data, organizing stored data, generating stored data and so on. Thus, in one embodiment, the data store 230 stores data used by the topological optimization module 222 in executing various functions.

In one example, the data store 230 may store input data 232 that the topological optimization process may use to create the absorber design 104, which may also be stored in the data store 230 after it is created. The input data 232 can include any data necessary for performing the topological optimization process so as to create the absorber design 104. As such, the input data 232 may include boundary conditions and constraints 234 material properties and structure dimensions, which the topological optimization process must consider when creating the absorber design 104. The boundary conditions and constraints 234 can include a frequency range and an absorption coefficient of the waves to be absorbed by the absorber.

In addition, the input data 232 can include the design domain 102, which may provide the design space that the absorber design 104 is designed within. Generally, the design domain 102 is inversely proportional to the frequencies of the vibrations to be absorbed for a given material in the design domain and/or varied based on the different densities of the material used to create the absorber 106. As such, designs of absorbers that are meant to absorb lower frequency vibrations generally require a larger design domain 102 than higher frequency absorption.

As mentioned before, the topological optimization module 222 includes instructions that cause the processor(s) 210 to perform any of the functions described herein. Accordingly, the topological optimization module generally includes instructions that function to control the processor(s) 210 to utilize the input data 232 and a topological optimization process to design a shape/structure (absorber design 104) of the absorber within the design domain 102 to maximize absorption performance of the absorber.

The topological optimization process is a mathematical method that optimizes material layout within the design domain 102 for a given set of boundary conditions and constraints with the goal of maximizing the performance of the system, in this case, absorption of vibrations acting upon a particular structure. The topological optimization process performed by the processor(s) 210 may use a finite element method (FEM) to evaluate the design performance. The design is optimized using either gradient-based mathematical programming techniques, such as the optimality criteria algorithm and the method of moving asymptotes, or non-gradient-based algorithms, such as genetic algorithms.

The optimization objective of the topological optimization process may be described in the following equation:

min{sumₗ^{N}(|Rₗ|²)},

where Rₗ=wᵣ/wᵢ, with wᵢ being an incident amplitude and wᵣ being a reflected displacement amplitude of the vibration, and l=1, 2, . . . . N is a frequency index. The frequency index is essentially a range of frequencies that the design should be able to absorb. As such, the optimization problem utilizes several inputs, including the design domain, the incident amplitude, reflected displacement amplitude, and/or the frequency index. In addition, other inputs may also be utilized, such as material properties of the material that will form the absorber, physical characteristics of the structure, such as the beam 12, etc. The absorber can be made out of any suitable material, such as acrylic, plastic, metals, ceramics, rubber, etc.

The absorber design 104 can be any type of data structure that electronically describes the absorber 106. For example, the absorber design 104 can be stored in the form of a 3D file format, such as OBJ, FBX, STL, AMF, IGES, and more. However, it should be understood that any type of methodology for storing the absorber design 104 can be utilized.

Once the absorber design 104 has been determined using the topological optimization process described above, the absorber design 104 may be fabricated. In one example, the topological optimization module 222 includes instructions that cause the processor(s) 210 to provide the absorber design 104 to a fabrication device, such as a 3D printer 240. The 3D printer 240 will then essentially print the absorber 106 that generally mimics the absorber design 104. Of course, it should be understood that other types of methodologies for manufacturing the design can be utilized as well. For example, more traditional forms of computer-aided manufacturing, such as the use of software to control machine tools in the manufacturing of the absorber 106, can also be utilized. Further still, the absorber design 104 could be converted into a set of human-readable design prints that allow a human to manufacture the absorber 106 using appropriate tools and materials.

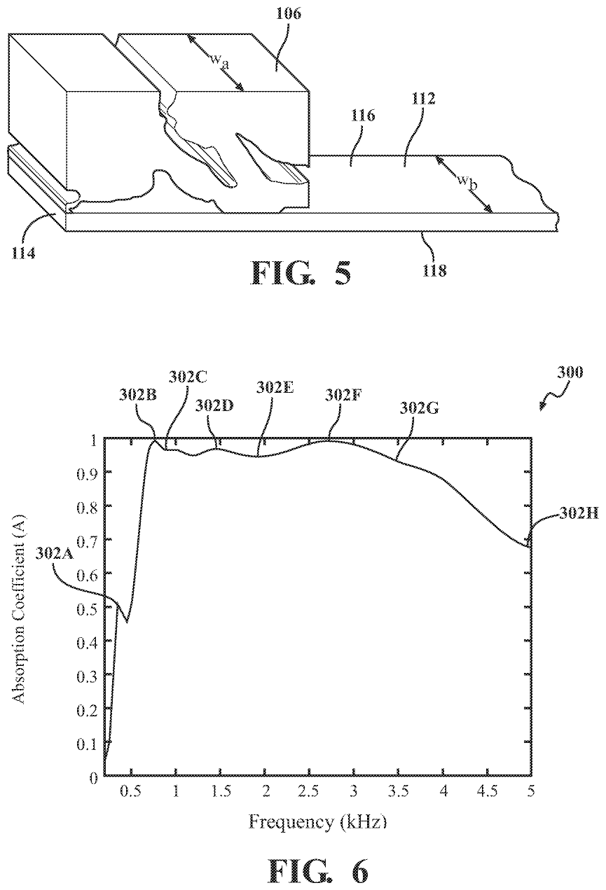

Once the absorber 106 has been fabricated, the absorber 106 can then be attached to the beam. For example, FIG. 5 illustrates the absorber 106 attached to the beam 112 and located generally near the end 114. As can be seen in this example, the absorber 106 typically has a width wₐ that is substantially similar to the width w_{b} of the structure, in this case, the width of the beam 112.

Here, the absorber 106 is attached to the top side 116 of the beam 112. However, as explained earlier when describing FIGS. 3A-3D, the absorber 106 can take a number of different designs and can be attached near the end 114 of the beam 112. For example, instead of being attached to the top side 116, the absorber 106 can be attached to the bottom side 118 or the end 114. Further still, the absorber 106 can be designed such that a portion of the beam 112, including the end 114, is inserted within the absorber 106. In other variations, the absorber 106 can be multiple parts, with some parts being attached to the top side 116 and other parts being attached to the bottom side 118 of the beam 112. When choosing other design domain, the topological optimization process needs to be repeated to get a new shape of absorber 106.

The methodology for attaching the absorber 106 to the beam 112 can vary from application to application. In some cases, the absorber 106 may be attached to the beam 112 using adhesives. However, in other cases, the absorber 106 may be attached to the beam 112 utilizing other fastening technologies, such as screws, nails, welding, or other type of methodology. Further still, it is also possible that the beam 112 and the absorber 106 may be a single unitary structure.

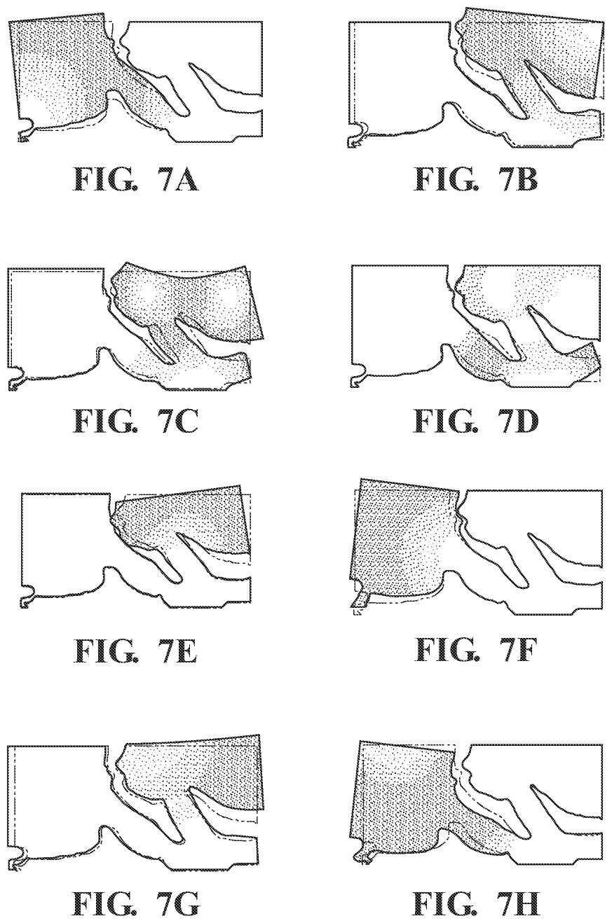

As mentioned previously, the absorber 106 is essentially a lightweight absorber that is able to absorb vibrations, such as flexural waves, acting upon the beam 112. In order to better understand how the absorber 106 is able to accomplish this, reference is made to FIGS. 6 and 7A-7H. FIG. 6 illustrates a chart 300, which plots the absorption coefficient of the designed absorber. In the optimization process, some interested frequency range is chosen and labeled as frequency indexes and the absorption coefficients at these different frequency indexes form the inputs to the topological optimization methodology used to generate the absorber design 104, which is then utilized to create the absorber 106. To explain the working mechanism, we performed a eigen analysis for the absorber 106. FIGS. 7A-7H illustrate the displacement field amplitudes or mode shapes (darker shading indicates greater amplitudes) of the absorber 106 at the frequency indexes 302A-302H, respectively. As such, the absorber 106 is able to absorb a broad range of frequencies of vibrations, such as flexural waves, acting upon the structure to which it is attached.

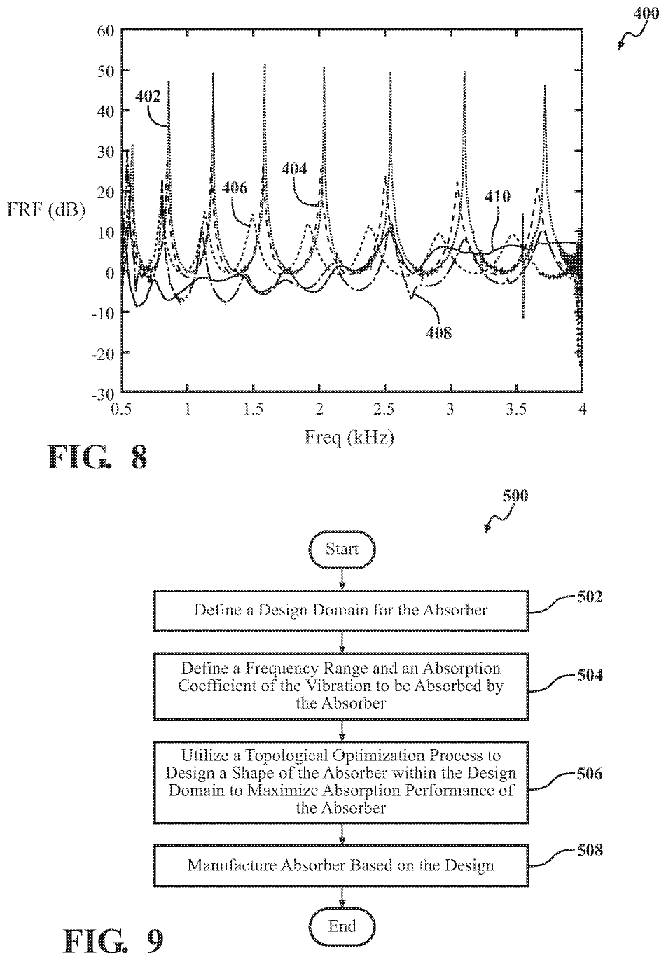

FIG. 8 illustrates the overall effectiveness of utilizing topological optimization to design a lightweight absorber, such as the absorber 106, in comparison to other methodologies. Moreover, FIG. 8 illustrates a chart 400 showing frequency (x-axis) and the frequency response function in dB (y-axis). The absorption performance of several different types of materials are shown, including bare beam 402 (no absorption material utilized), tip-coated 404, whole-layer-coated 406, and two different types 408 and 410 of lightweight absorbers designed utilizing the topological optimization methodology described herein. As can be seen, the two different types 408 and 410 of lightweight absorbers outperform the tip-coated 404 and the whole-layer-coated 406 methodologies.

Referring to FIG. 9, a method 500 for designing an absorber for absorbing a vibration acting upon a structure is shown. The method 500 will be described from the viewpoint of the design system 200 of FIG. 4. However, it should be understood that this is just one example of implementing the method 500. While method 500 is discussed in combination with the design system 200, it should be appreciated that the method 500 is not limited to being implemented within the design system 200, but is instead one example of a system that may implement the method 500.

In step 502, a design domain 102 is defined for the absorber. Typically, the design domain 102 is a two-dimensional space having a length and a height. The width is typically a fixed amount that matches the width of the structure, such as the width of the beam 12. In step 504, which may be performed before, after, or concurrently with step 502, a frequency range and absorption coefficients of the vibrations to be absorbed by the absorber are defined. Essentially, the design domain 102, absorption coefficients, and frequency ranges may form some or all the inputs provided to the topological optimization process. However, other inputs may also be used, such as material properties of the material used to fabricate the absorber, structural information regarding the structure that the absorber will be attached to, and other information.

In step 506, the topological optimization module 222 includes instructions that cause the processor(s) 210 to utilize a topological optimization process to design a shape/structure (absorber design 104) of the absorber within the design domain 102 to maximize the absorption performance of the absorber utilizing boundaries and constraints previously provided, such as absorption coefficient and frequency range to be absorbed. As mentioned before, the topological optimization process is a mathematical method that optimizes material layout within the design domain 102 for a given set of boundary conditions and constraints with the goal of maximizing the performance of the system, in this case, absorption of vibrations acting upon a particular structure. In one particular example, the topological optimization process uses an objective function that minimizes a reflection coefficient or maximizes an absorption coefficient to generate the absorber design 104.

Once the absorber design 104 has been generated, the method 500 proceeds to step 508, wherein the absorber 106 is manufactured based on the absorber design 104. In some cases, the absorber design 104 may be provided to a 3D printer that will essentially print the absorber 106. However, as explained earlier, other manufacturing processes can also be utilized to manufacture the absorber 106. It should be understood that these processes are not just limited to 3D printing but any type of process that can be utilized to fabricate the absorber 106.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements can also be embedded in an application product that comprises all the features enabling the implementation of the methods described herein and which, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, partly on a stand-alone software package, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method for designing an absorber for absorbing a vibration acting upon a structure, the method comprising steps of:
defining a design domain for the absorber; and
utilizing a topological optimization process to design a shape of the absorber within the design domain to maximize absorption performance of the absorber.

2. The method of claim 1, further comprising the step of defining a frequency range and an absorption coefficient of the vibration to be absorbed by the absorber to be used by the topological optimization process.

3. The method of claim 2, wherein the topological optimization process uses an objective function that minimizes a reflection coefficient or maximizes the absorption coefficient.

4. The method of claim 1, wherein an optimization objective of the topological optimization process is:
min{sumₗ^{N}(|Rₗ|²)},
where Rₗ=wᵣ/wᵢ, with wᵢ being an incident and wᵣ being a reflected displacement amplitude of the vibration, and l=1, 2, . . . N is a frequency index.

5. The method of claim 1, wherein a width of the absorber is equal to a width of the structure.

6. The method of claim 1, further comprising the step using a finite element method to evaluate the absorption performance of the absorber.

7. The method of claim 1, wherein the absorber is configured to be connected near an end of the structure.

8. The method of claim 7, wherein the structure is a beam.

9. The method of claim 8, wherein the absorber is configured to allow the beam to be partially inserted into the absorber.

10. The method of claim 8, wherein the absorber is configured to be attached to at least one side of the beam.

11. The method of claim 1, wherein the vibration is one or more flexural waves acting upon the structure.

12. The method of claim 1 wherein a size of the design domain is at least one of:
inversely proportional to a frequency of the vibration to be absorbed for a given material in the design domain; and
varied based on different densities of material.

13. An absorber for absorbing a vibration acting upon a structure, the absorber designed using a topological optimization process to design a shape of the absorber within a design domain that maximizes absorption performance of the absorber.

14. The absorber of claim 13, wherein the topological optimization process uses an objective function that minimizes a reflection coefficient or maximizes an absorption coefficient.

15. The absorber of claim 13, wherein an optimization objective of the topological optimization process is:
min{sumₗ^{N}(|Rₗ|²)},
where Rₗ=wᵣ/wᵢ, with wᵢ being an incident and wᵣ being a reflected displacement amplitude of the vibration, and l=1, 2, . . . N is a frequency index.

16. The absorber of claim 13, wherein the structure is a beam.

17. The absorber of claim 16, wherein the absorber is configured to be connected near an end of the beam.

18. The absorber of claim 16, wherein the absorber is configured to allow the beam to be partially inserted into the absorber.

19. The absorber of claim 16, wherein the absorber is attached to at least one side of the beam.

20. The absorber of claim 13, wherein a size of the design domain is at least one of:
inversely proportional to a frequency of the vibration to be absorbed; and
varied based on different densities of material.
